(19) United States
(12) Patent Application Publication
(10) Pub. No.: US 2015/0097097 A1
(43) Pub. Date: Apr. 9, 2015

(54) HOOK ARRANGEMENT DEVICE AND METHOD OF USE

(71) Applicant: Sean M. Early, Dublin, CA (US)

(72) Inventor: Sean M. Early, Dublin, CA (US)

(21) Appl. No.: 14/506,813

(22) Filed: Oct. 6, 2014

Related U.S. Application Data
(60) Provisional application No. 61/887,617, filed on Oct. 7, 2013.

(51) Int. Cl. A47F 5/00; F16B 2/20; F16B 2/10

(52) U.S. Cl. CPC A47F 5/0006; F16B 2/10; F16B 2/20
USPC 248/215

(57) ABSTRACT

The present invention discloses a hook arrangement device for hanging items along a rack or bar comprising: (1) a body portion adapted to securely attach to the rack or bar wherein the body portion is locked into a position along the rack or bar; and (2) at least one hook portion having at least one first segment extending substantially vertically downward from the bottom section of the body portion and having at least one second segment extending outwardly to receive hanging items.

### RELATED APPLICATIONS

This application claims priority to U.S. Provisional Application No. 61/887,617 filed Oct. 7, 2013. The entire contents of the above application are hereby incorporated by reference as though fully set forth herein.

### BACKGROUND

The present invention relates in general to hook arrangement devices for hanging clothing, towels or other articles. In particular, the present invention relates to a removable hook arrangement device designed to affix to a rod or bar in order to maximize article storage space when the article is not in use. Traditionally, living spaces are stuck with one-dimensional standard towel/garment racks and shower door/handle racks, collectively referred to herein as “article racks”. Most new or existing article racks can only hold one or two articles at a time.

Hooks for hanging articles are well known in the prior art. However, most hooks must be used separately or independent of an existing article rack or have to be attached to a wall or door via screws, nails, tape, Velcro or some other means of permanent or semi permanent attachment. There exists a need for a hook arrangement device that allows the addition of multiple hooks to an existing article rack without having to permanently or semi permanently attach anything to walls or doors, thereby eliminating the need to find new space to attach new hooks.

One solution is disclosed in U.S. Pat. No. 8,381,374 to Henry et. al., wherein a shower curtain fastener also serves as a towel hook. While this invention is useful for a shower curtain bar that requires the fasteners to slide along the bar, it does not provide a stable means for a permanent or semi permanent fixture that can be used for article storage. Another solution is disclosed in U.S. Design Pat. No. 397,296 to Goodman et. al., wherein the towel bar comes equipped with a towel hook unit below the bar. This invention does not allow for additions to the existing towel bar, nor does it provide an option to remove hooks if needed.

An object of the present invention is to provide a hook arrangement device for hanging clothing, towels or other articles that can be added to an existing article rack in order to securely retain the article on the hook of the device. A further object of the present invention is to provide a hook arrangement device that permits secure and simple attachment to an existing article rack, thereby eliminating the need to find other space for the hook on a wall, door or other surface.

### BRIEF SUMMARY OF THE INVENTION

A hook arrangement device for hanging clothing, towels or other articles according to the present invention achieves these and other objects. According to one embodiment, a hook arrangement device for hanging clothing, towels or other articles is disclosed, the device comprising: (1) a body portion adapted to securely attach to an article rack wherein the body portion is locked into a position along the article rack; and (2) at least one hook portion having at least one first segment extending substantially vertically downward from the bottom section of the body portion and having at least one second segment extending outwardly to receive hanging items.

In at least one embodiment, the body portion is substantially ring shaped to accommodate attachment to a substantially round bar. In at least one embodiment, the body portion is substantially rectangular shaped to accommodate attachment to a substantially rectangular bar.

In at least one embodiment, the device further comprises a locking closure for releasable securing said body portion around said article rack. In at least one embodiment, the locking closure is a clipping mechanism. In at least one embodiment, the locking closure is a clamping mechanism. In at least one embodiment, the locking closure mechanism comprises a protruding portion extending from the body portion at one end of the locking closure opening, the distal end of the protruding portion having an enlarged head which is adapted to be inserted into a socket formed within the body portion adjacent to the opposite end of the locking closure opening.

In at least one embodiment, the body portion further comprises a hinge mechanism for attaching the body portion to said article rack.

In the preferred embodiment, the interior of the body portion is lined with a material capable of gripping the bar to prevent movement and help secure the device in place on the bar.

### BRIEF DESCRIPTION OF THE DRAWINGS

FIG. 1 is a perspective view of the present invention.

FIG. 2 is a perspective view of the present invention functioning as a garment holder.

FIG. 3. FIG. 2 is a side view of the present invention in the closed and locked position.

FIG. 4 is a side view of the present invention in the open and unlocked position.

FIG. 5 is a side view of one embodiment of the locking mechanism of the present invention.

FIG. 6 is a side view of a second embodiment of the locking mechanism of the present invention.

FIG. 7 is perspective side view of an alternative embodiment of the present invention.

FIG. 8 is side view of an alternative embodiment of the present invention.

FIG. 9 is a side view of an alternative embodiment of the present invention.

### DETAILED DESCRIPTION

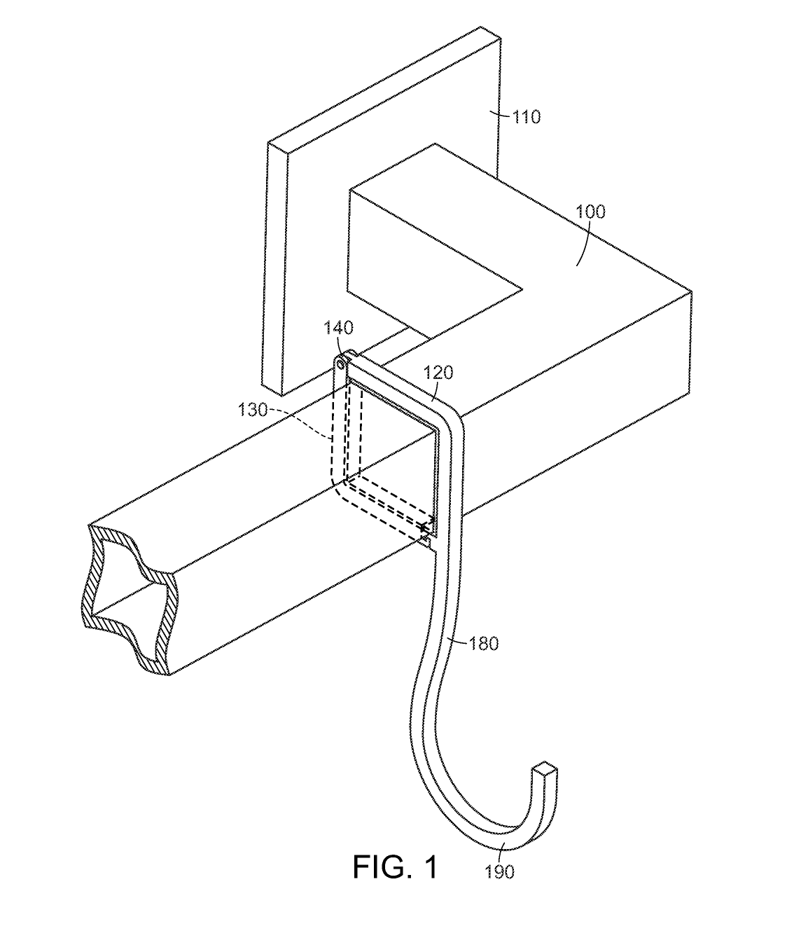

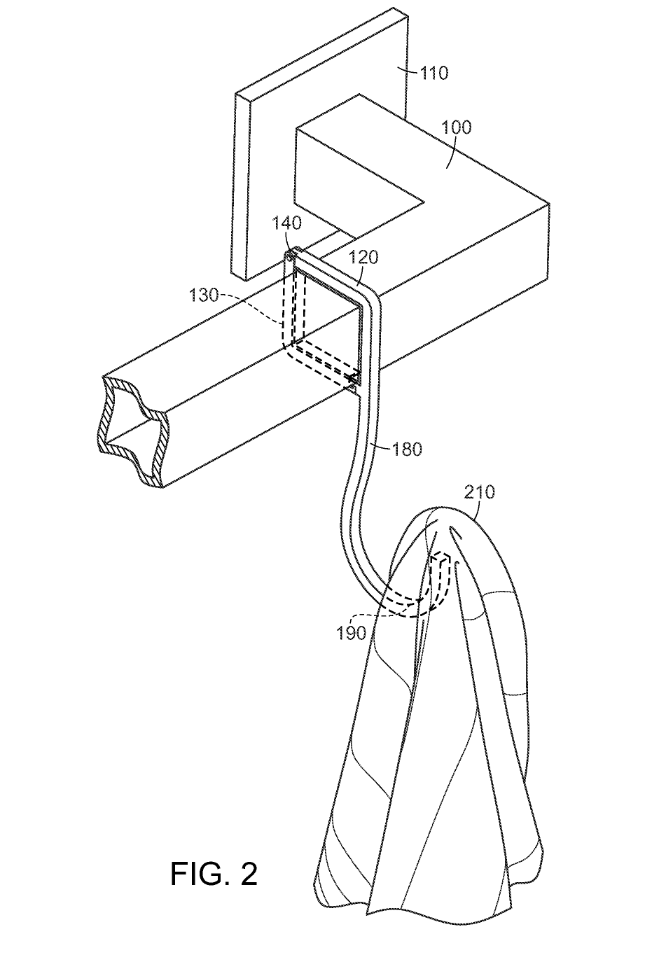

Turning to FIG. 1, a hook arrangement device is displayed generally wherein the device is locked into position around a bar 100 that is connected to a base anchor attachment 100. The bar 100 may be of any shape and the device may be of any matching shape of the bar. As shown herein, the bar 100 is rectangular shaped and the device is shaped rectangular correspondingly. A first body portion 120 is connected on one side via a hinge assembly 140 to a second body portion 130 and on the other side is connected to a hook first portion 180 having at least one first segment extending substantially vertically downward from the bottom section of the first body portion 120 and having a second hook portion 190 extending outwardly to receive hanging items. As shown in FIG. 2, the second hook portion 190 is used to hang a garment 210, herein generally represented as a towel or other piece of cloth.

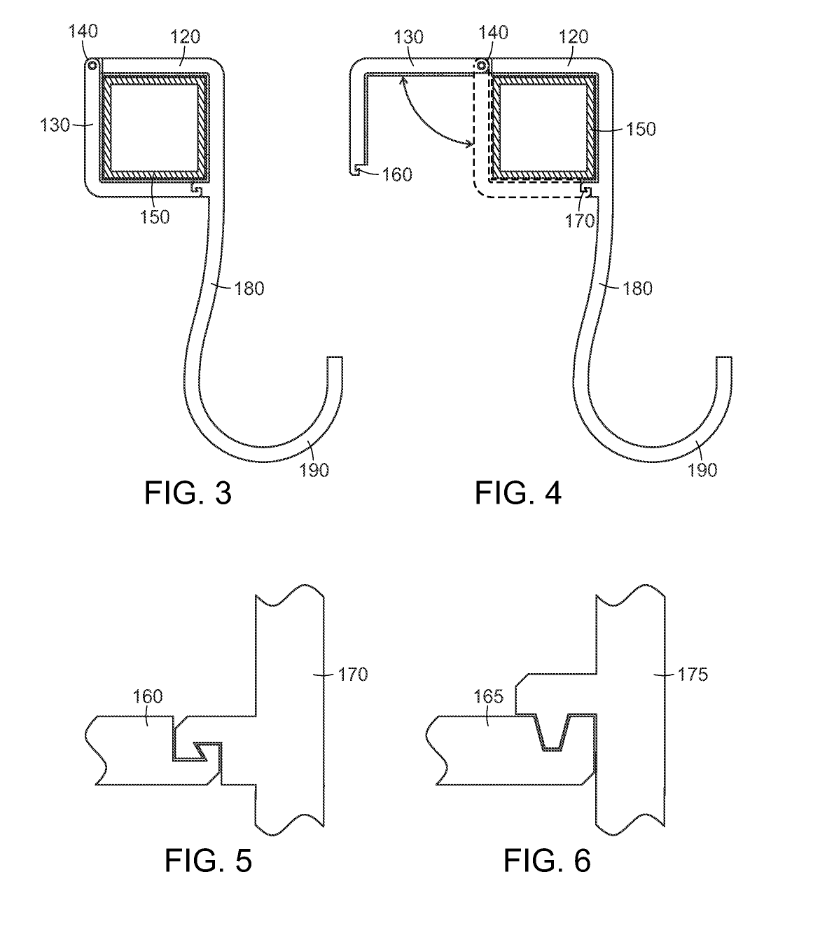

Turning to FIGS. 3 and 4, when the device is in the locked position as shown in FIG. 3, a gripping surface 150 makes contact with the bar 100. The gripping substance may be of any material suitable to prevent the device from moving around the bar 100 or laterally across the bar 100 and also serves to help lock the device in place around the bar 100. For example, the surface 150 may be selected from the group comprising silicon, rubber, soft plastic, foam, non slip pad, tacky surface or other material suitable to “grip” or form friction with the bar material. When the device is in the open position, as shown in FIG. 4, the second body portion 130 is moved away from the bar 100 using hinge 140. The locking mechanism pieces of the preferred embodiment are shown in FIGS. 4-7, wherein first locking end 160 has a protruding portion that extends from the second body portion 130 at one end of the locking closure opening and the distal end of the protruding portion having an enlarged head which is adapted to be inserted into a socket 170 formed within the second body portion 130 and adjacent to the opposite end of the locking closure opening.

Alternative embodiments of locking closures are shown in FIGS. 5 and 6, wherein the first locking end 160 or 165 fit into the second locking end 165 or 175, respectively using various shapes to create a lock between first body portion 120 and second body portion 130. However, the device may be locked into place in any number of ways, including, but not limited to, clipping or clamping mechanisms.

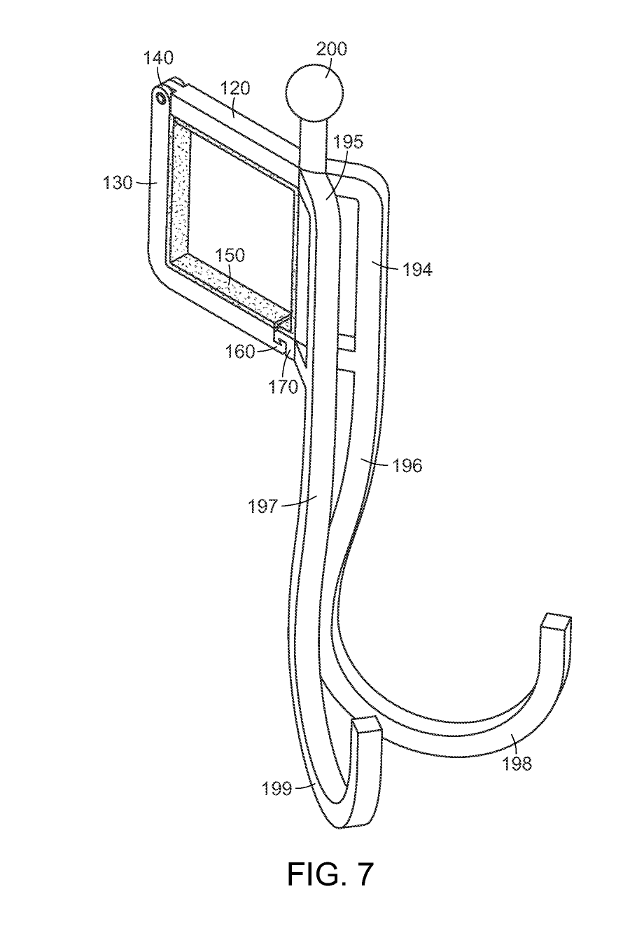

An alternative embodiment of the present invention is shown in FIG. 7 wherein there is a “dual hook” presentation. A first dual hook extension 194 is connected to a hook first portion 196 having at least one first segment extending substantially vertically downward from the bottom section of the first hook extension 194 and having a second hook portion 198 extending outwardly to receive hanging items. A second hook extension 195 is connected to a hook second portion 197 having at least one first segment extending substantially vertically downward from the bottom section of the second hook extension 197 and having a second hook portion 199 extending outwardly to receive hanging items. The device may further comprise a decorative knob 200 located above first body portion and at the intersection of first body portion 120, first hook extension 194 and second hook extension 195.

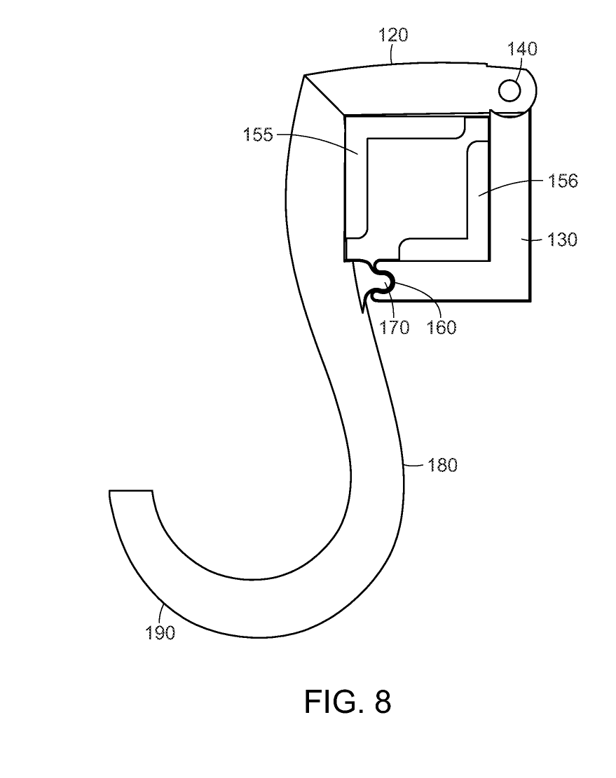

Turning to FIG. 8, an alternative embodiment of the rectangular shaped version wherein the gripping surface is shown where the gripping surfaces 155 and 156 only partially lines the interior of the first body portion 120 and second body portion 130, respectively.

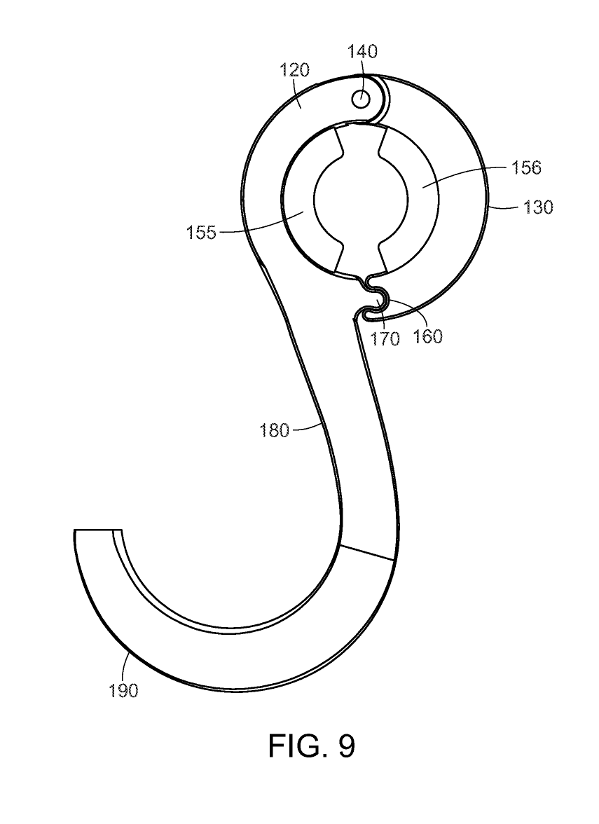

Turning to FIG. 9, an alternative embodiment of the round shaped version wherein the gripping surface is shown where the gripping surfaces 155 and 156 only partially lines the interior of the first body portion 120 and second body portion 130, respectively.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A hook arrangement device for hanging items along a rack or bar comprising:
(1) a substantially ring shaped body portion adapted to securely attach to the rack or bar wherein the body portion is locked into a position along the rack or bar; and
(2) at least one hook portion having at least one first segment extending substantially vertically downward from the bottom section of the body portion and having at least one second segment extending outwardly to receive hanging items.

2. The hook arrangement device of claim 1 further comprising a hinge mechanism for attaching to body portion to the rack or bar.

3. The hook arrangement device of claim 1 further comprising a non-slip material fully or partially lining the interior of the body portion.

4. The hook arrangement device of claim 1 further comprising a locking closure for releasably securing said body portion around said rack or bar.

5. The hook arrangement device of claim 5 wherein the locking closure mechanism comprises a protruding portion extending from the body portion at one end of the locking closure opening, the distal end of the protruding portion having an enlarged head which is adapted to be inserted into a socket formed within the body portion adjacent to the opposite end of the locking closure opening.

6. The hook arrangement device of claim 5 wherein the locking closure is a clipping mechanism.

7. The hook arrangement device of claim 5 wherein the locking closure is a clamping mechanism.

8. A hook arrangement device for hanging items along a rack or bar comprising:
(1) a substantially rectangular shaped body portion adapted to securely attach to the rack or bar wherein the body portion is locked into a position along the rack or bar; and
(2) at least one hook portion having at least one first segment extending substantially vertically downward from the bottom section of the body portion and having at least one second segment extending outwardly to receive hanging items.

9. The hook arrangement device of claim 8 further comprising a hinge mechanism for attaching to body portion to the rack or bar.

10. The hook arrangement device of claim 8 further comprising a non-slip material fully or partially lining the interior of the body portion.

11. The hook arrangement device of claim 8 further comprising a locking closure for releasably securing said body portion around said rack or bar.

12. The hook arrangement device of claim 11 wherein the locking closure mechanism comprises a protruding portion extending from the body portion at one end of the locking closure opening, the distal end of the protruding portion having an enlarged head which is adapted to be inserted into a socket formed within the body portion adjacent to the opposite end of the locking closure opening.

13. The hook arrangement device of claim 12 wherein the locking closure is a clipping mechanism.

14. The hook arrangement device of claim 12 wherein the locking closure is a clamping mechanism.

15. A method for hanging items along a bar or rack comprising:
(1) securely attaching to the bar or rack a hook arrangement device comprising:
(a) body portion adapted to securely attach to the rack or bar wherein the body portion is locked into a position along the rack or bar; and
(b) at least one hook portion having at least one first segment extending substantially vertically downward from the bottom section of the body portion and having at least one second segment extending outwardly to receive hanging items.
(2) hanging items on the at least one hook portion.

16. The method of claim 15 wherein the hook arrangement device further comprises a hinge mechanism for attaching to body portion to the rack or bar.

17. The method of claim 15 wherein the hook arrangement device further comprises a non-slip material fully or partially lining the interior of the body portion.

18. The method of claim 15 wherein the hook arrangement device further comprises a locking closure for releasably securing said body portion around said rack or bar.

19. The method of claim 15 wherein the body portion is substantially ring shaped.

20. The method of claim 15 wherein the body portion is substantially rectangular shaped.
